(19) United States
(12) Patent Application Publication
(10) Pub. No.: US 2021/0024311 A1
(43) Pub. Date: Jan. 28, 2021

(54) DOUBLE FEED DETECTION USING LOAD SENSOR

(71) Applicant: HEWLETT-PACKARD DEVELOPMENT COMPANY, L.P., Spring, TX (US)

(72) Inventors: Eiji AOKI, Suwon (KR); Jinsoo LEE, Suwon (KR)

(73) Assignee: HEWLETT-PACKARD DEVELOPMENT COMPANY, L.P., Spring, TX (US)

(21) Appl. No.: 16/976,652

(22) PCT Filed: Apr. 9, 2019
(86) PCT No.: PCT/US2019/026593

§ 371 Date: Aug. 28, 2020

(30) Foreign Application Priority Data
Apr. 13, 2018 (KR) 10-2018-0043062

(51) Int. Cl. B65H 7/12; B65H 7/20; B65H 5/06; B41J 11/00; B41J 11/04

(52) U.S. Cl. CPC B65H 7/12; B65H 7/20; B41J 11/04; B41J 11/006; B65H 5/062

(57) ABSTRACT

An image forming apparatus including a print engine to form an image on an image forming medium, a conveyance device to provide printing paper using a feed roller and a conveyance roller installed to face the feed roller to the print engine, a sensor to sense pressure applied to the conveyance roller, and a processor to identify whether double feed occurs on the basis of a signal provided from the sensor.

### CROSS REFERENCE TO RELATED APPLICATIONS

This application is a U.S. National Stage Application which claims the benefit under 35 U.S.C. § 371 of International Patent Application No. PCT/US2019/026593, filed on Apr. 9, 2019, which claims priority to Korean Application No. 10-2018-0043062, filed on Apr. 13, 2018, the contents of which are incorporated herein by reference.

### BACKGROUND

An image forming apparatus is an apparatus for generating, printing, receiving, and transmitting image data. Examples of the apparatus include a printer, a copier, a facsimile, and a multi-function printer (MFP) integrally incorporating these functions.

The image forming apparatus includes a print engine that prints an image on a print sheet and a conveyance path that conveys the print sheet to the print engine.

### BRIEF DESCRIPTION OF THE DRAWINGS

FIG. 1 is a block diagram illustrating a simple configuration of an image forming apparatus of the present disclosure.

FIG. 2 is a block diagram illustrating a configuration of an image forming apparatus of the present disclosure.

FIG. 3 is a configuration view of an image forming part of FIG. 1.

FIG. 4 is a view schematically illustrating the image forming apparatus of FIG. 1.

FIG. 5 is a view schematically illustrating an example of a conveyance device according to an example of the present disclosure.

FIG. 6 is a view illustrating a feed roller and a transfer roller of the conveyance device of FIG, 5.

FIG. 7A is a view for explaining pressure measured by a load sensor (or a pressure sensor) when one sheet of printing paper is transferred on a conveyance device according to an example of the present disclosure,

FIG. 7B is a view for explaining pressure measured by a load sensor when two or more sheets of printing paper are double-fed on the conveyance device according to the example of the present disclosure.

FIG. 8 is a view illustrating signals sensed by a sensor of a conveyance device according to an example of the present disclosure.

FIG. 9A is a view illustrating a position of printing paper at a position A of FIG. 8.

FIG. 9B is a view illustrating a position of printing paper at point B of FIG. 8.

FIG. 10 is a view illustrating a feed roller and a transfer roller of a conveyance device according to another example of the present disclosure.

FIG. 11 is a flowchart for explaining a double feed sensing method in an image forming apparatus of the present disclosure,

### DETAILED DESCRIPTION

The related art image forming apparatus prints an image as is without any action in case of double feed of two or more sheets of printing paper on the conveyance path. Therefore, a printing defect that an image corresponding to the amount of one page is printed on two or more sheets of printing paper occurs, and in this case, a user locates and removes the print-detective page and the corresponding page is re-printed. This causes a waste of printing paper and ink or a toner and user inconvenience due to re-printing.

Hereinafter, various examples will be described in detail with reference to the drawings. The examples described below may be modified to be implemented in various different forms, In order to more clearly describe the features of the examples, a detailed description of matters known to those skilled in the art will be omitted.

In the disclosure, when it is described that an element is “coupled” to another element, the element may be “directly coupled” to the other element or “coupled” to the other element through a third element. In addition, unless explicitly described to the contrary, the word “comprise” and variations such as “comprises” or “comprising”, will be understood to imply the inclusion of stated elements but not the exclusion of any other elements.

In the disclosure, an “image forming job” may denote any one of various jobs (for example, printing, copying, scanning, and faxing) related to an image, such as forming an image or generating/storing/transmitting an image file, and a “job” may denote an image forming job but may also denote a series of processes to perform the image forming job.

Also, an “image forming apparatus” refers to an apparatus printing print data generated in a terminal device such as a computer on a recording paper. Examples of the image forming apparatus includes a copier, a printer, a facsimile, or a multi-function printer (MPF) complexly realizing these functions through a single apparatus. The “image forming apparatus may refer to any apparatus capable of performing an image forming job, such as a printer, a scanner, a fax machine, a multi-function printer (MFP), and a display apparatus.

Also, “hard copy” may refer to an operation of outputting an image to a printing medium such as paper, and “soft copy” may refer to an operation of outputting an image on a display apparatus such as a TV, a monitor, or the like.

Also, “content” may refer to any type of data that is a target of an image forming job, such as a picture, an image, a document file, and the like.

Also, “print data” may refer to data converted into a format printable by a printer. Meanwhile, if a printer supports direct printing, a file itself may be print data.

Also, a “user” may refer to a person who performs an operation related to an image forming job using an image forming apparatus or using a device connected to the image forming apparatus wirelessly or wiredly. Also, “manager” may refer to a person having authority to access every function and system of an “image forming apparatus”. “Manager” and “user” may be the same person.

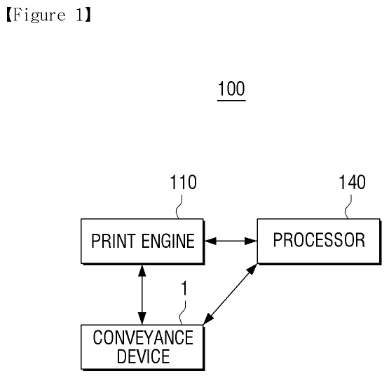

FIG. 1 is a block diagram illustrating a simple configuration of an image forming apparatus according to an example of the present disclosure.

Referring to FIG. 1, an image forming apparatus 100 includes a print engine 110, a conveyance device 1, and a processor 140.

Here, the image forming apparatus 100 is an apparatus for generating, printing, receiving, or transmitting image data, which includes a printer, a copier, a facsimile, and a multi-function printer (MFP) which integrating these functions. Although this example is described as being applied to an image forming apparatus for forming an image, it may also be applied to an image reading apparatus such as a scanner.

The print engine 110 performs an image forming job. The print engine 110 may perform an image forming job by performing an operation of forming an image on an image forming medium and transferring the formed image to printing paper.

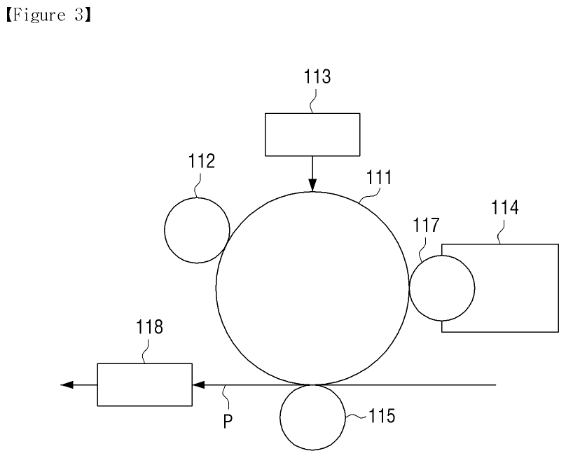

In the present disclosure, it is described that the print engine 110 performs the image forming job, but in case where the image forming apparatus 100 is a scanner or an MFP capable of performing a scanning operation, the print engine 110 may be a component for performing an image reading job. A detailed configuration of the print engine 110 will be described with reference to FIG. 3.

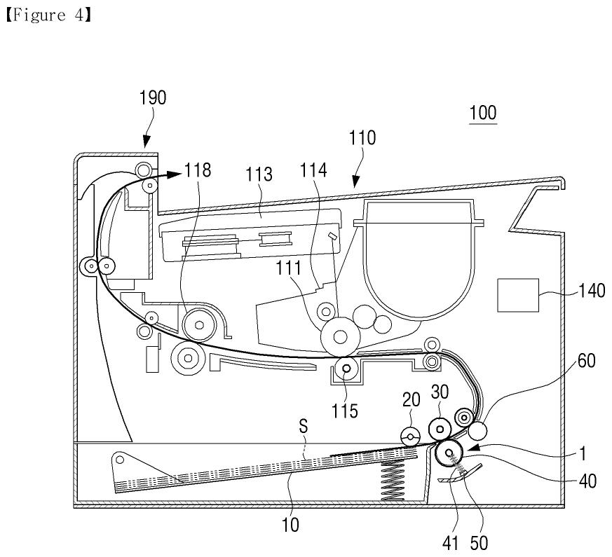

The conveyance device 1 moves loaded printing paper to the transfer path. The conveyance device 1 may pick up the printing paper loaded in a cassette 10 (See FIG. 4) and transfer the picked-up printing paper to the transfer path, so that the printing paper may be supplied to the printing engine 110. To this end, the conveyance device 1 may include at least one driving source and a plurality of rollers. A configuration and operation of the conveyance device 1 will be described later with reference to FIG. 4.

The processor 140 controls each component of the image forming apparatus 100. When print data is received from a print control terminal device, the processor 140 may control an operation of the print engine 110 so that the received print data is printed, and control the conveyance device 1 so that the printing paper is provided to the print engine 11.

As an example, the processor 140 identifies (or determines) whether double feed occurs on the basis of a signal provided by a load sensor (or a pressure sensor) 50 (to be described later). When it is determined that double feed occurs, the processor 140 may control the conveyance roller 40 to be driven in a direction opposite to the transfer direction of the printing paper S. Here, when the transfer roller 30 is driven in the reverse direction, the processor 140 may determine double feed on the basis of a signal from the load sensor 50.

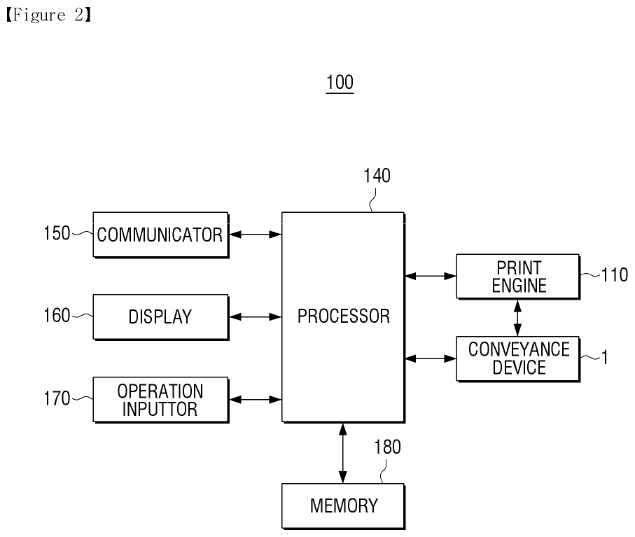

FIG. 2 is a block diagram illustrating a configuration of an image forming apparatus according to an example of the present disclosure.

Referring to FIG. 2, an image forming apparatus 100 according to an example of the present disclosure may include a print engine 110, a conveyance device 1, a processor 140, a communicator 150, a display 160, an operation inputter 170, and a memory 180.

The print engine 110, the conveyance device 1, and the processor 140 perform the same functions as those in FIG. 1, and thus, a redundant description will be omitted.

The communicator 150 may be connected to a print control terminal device (not shown) and receive print data from the print control terminal device. The communicator 150 may connect the image forming apparatus 100 to an external device and may be connected to a terminal device via a local area network (LAN) or via the Internet or via a universal serial bus (USB) port or a wireless communication (e.g., Wi-Fi 802.11a/b/g/n, NFC, Bluetooth) port. Here, the print control terminal device may be a general PC, a notebook, or a mobile device such as a smartphone.

The communicator 150 receives print data from the print control terminal device. Further, when the image forming apparatus 100 has a scanner function, the communicator 150 may transmit generated scan data to the print control terminal device or an external server (not shown).

The communicator 150 may receive information on printing paper loaded in a cassette of the image forming apparatus 100.

The display 160 displays various types of information provided by the image forming apparatus 100. The display 160 may display an operational state of the image forming apparatus 100 or may display a user interface window for selecting functions and options that the user may select. The display 160 may be a monitor such as an LCD, a CRT, or the like, and may be implemented as a touch screen capable of simultaneously performing functions of an operation inputter 170 (to be described later).

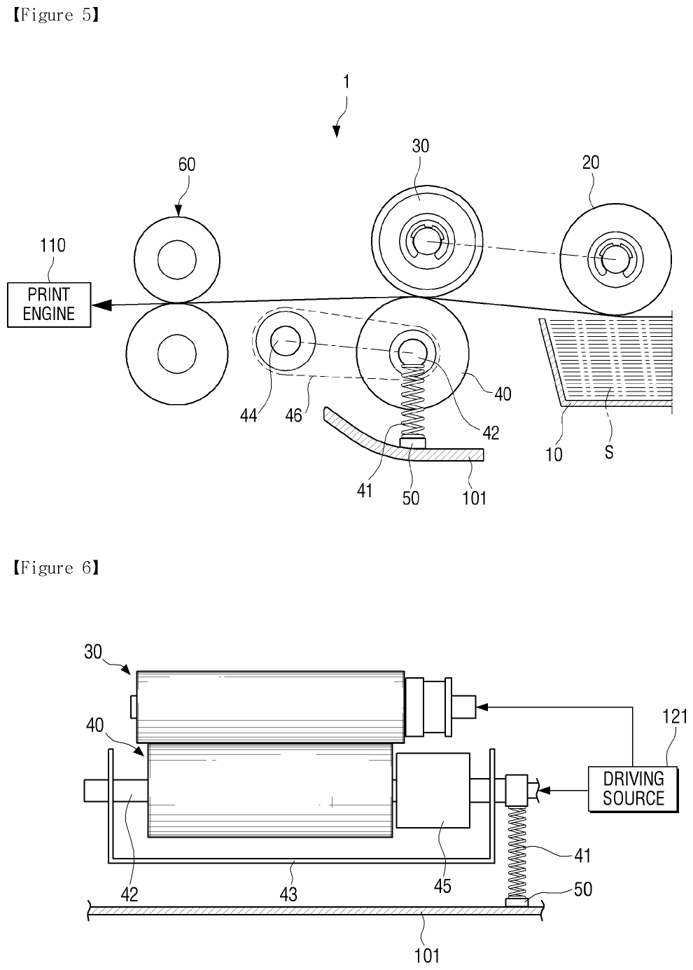

The display 160 displays an operation state of the image forming apparatus 100. When double feed is sensed using the load sensor 50 (See FIG. 5) (to be described later), the display 160 may display information indicating the double feed.

If a pressure value regarding a certain printing paper S is outside a predetermined range, the processor 140 may determine occurrence of double feed and control the display 160 to display double feed occurrence message. Accordingly, the user may determine whether double feed has occurred upon viewing the message displayed on the display 160.

The operation inputter 170 includes a plurality of function keys with which the user may set or select various functions supported by the image forming apparatus 100. The operation inputter 170 may be implemented as a device such as a mouse, a keyboard, or the like, and may be implemented as a touch screen capable of simultaneously performing the function of the display 160 described above. Accordingly, the user may input various driving commands to the image forming apparatus 100.

The operation inputter 170 may receive various types of information related to printing paper to be used for a printing operation, Here, various types of information related to the printing paper may be a paper size, coating information, thickness information, and the like.

The memory 180 may store print data. The memory 180 may store the print data received from the communicator 150 described above. The memory 180 may be implemented as an external storage medium, a removable disk including a USB memory, a Web server through a network, and the like, as well as a storage medium inside the image forming apparatus 100.

The memory 180 may store a look-up table for controlling the conveyance device 1. Here, the lookup table may be information regarding a printing environment and a pickup time point for each printing paper or information on a pickup time point for each delay time.

The memory 180 may store information on pressure applied to the conveyance roller 40 when no double feed occurs.

As described above, the image forming apparatus 100 according to the present example determines double feed when double feed occurs, and controls driving of the conveyance roller 40 and feed roller 30, and thus, the image forming apparatus 100 according to the present example may take immediate action. Accordingly, the image forming apparatus may prevent occurrence of skew and jamming of the printing paper S.

FIG. 3 is a configuration view according to an example of the print engine of FIG. 1.

Referring to FIG. 3, the print engine 110 may include a photosensitive drum 111, a charger 112, an exposure device 113, a developing device 114, a transfer machine 115, and a fixing device 118. In FIG. 1, it is illustrated that the print engine 110 and the conveyance device 1 are different components, but the conveyance device 1 may be a component of the print engine 110.

An electrostatic latent image is formed on the photosensitive drum 111. An image may be formed on the photosensitive drum 111 by an operation of the charger 112 and the exposure device 113 (to be described later). The photosensitive drum 111 may be referred to as an image forming medium, a photosensitive drum, a photosensitive belt, or the like, according to forms thereof.

Hereinafter, the configuration of the print engine 110 corresponding to one color will be described for ease of explanation, but when realized, the print engine 110 may include a plurality of photosensitive drums 111, a plurality of chargers 112, a plurality of exposure devices 113, a plurality of developing devices 114, and an intermediate transfer belt.

The charger 112 charges a surface of the photosensitive drum 111 with a uniform potential. The charger 112 may be implemented in the form of a corona charger, a charging roller, a charging brush, or the like.

The exposure device 113 changes a surface potential of the photosensitive drum 111 according to image information to be printed, thereby forming an electrostatic latent image on the surface of the photosensitive drum 111. As an example, the exposure device 113 may form an electrostatic latent image by irradiating light modulated according to image information to be printed, to the photosensitive drum 111. This type of exposure device 113 may be referred to as a light scanning device, or the like, and an LED may be used as a light source.

The developing device 114 accommodates a developer therein and supplies the developer (e.g., toner) to the electrostatic latent image to develop the electrostatic latent image into a visible image. The developing device 114 may include a developing roller 117 that supplies the developer to the electrostatic latent image, For example, the developer may be supplied from the developing roller 117 to the electrostatic latent image formed on the photosensitive drum 111 by a developing electric field formed between the developing roller 117 and the photosensitive drum 111.

A visible image formed on the photosensitive drum 111 is transferred to the printing paper by the transfer machine 115 or the intermediate transfer belt (not shown). The transfer machine 115 may transfer the visible image to the printing paper by, for example, an electrostatic transfer method. The visible image is adhered to the printing paper by electrostatic attraction.

The fixing device 118 applies heat and/or pressure to the visible image on the printing paper to fix the visible image on the printing paper. The printing operation is completed by the series of processes.

Meanwhile, the conveyance device 1 may perform an operation of rotating each component of the print engine 110 described above. Meanwhile, when realized, one conveyance device 1 may simultaneously rotate a plurality of components of the print engine 110, and a plurality of motors may be combined to rotate the plurality of components described above.

A configuration of the conveyance device 1 will be described with reference to FIG. 4 hereinafter.

FIG. 4 is a view schematically illustrating an image forming apparatus of FIG. 1. Hereinafter, an image forming apparatus 100 having a conveyance device according to an example of the present disclosure will be described with reference to FIG. 4.

Referring to FIG. 4, an image forming apparatus 200 according to an example of the present disclosure may include the conveyance device 1, the print engine 110, and a paper discharger 190. The conveyance device 1 accommodates a predetermined number of sheets of printing paper S and is to pick up the sheets of printing paper S one by one and supply the sheets to the printing engine 110. The structure and operation of the conveyance device 1 will be described later.

As described above, the print engine 110 forms a predetermined image on the printing paper S supplied from the conveyance device 1.

The conveyance device 1 according to the present disclosure may also be applied to an inkjet printer. Thus, although not shown, an image forming part may be an ink jet head which jets predetermined ink according to print data.

The paper discharger 190 discharges the printing paper with the predetermined image formed thereon through the printing engine 110 to the outside of the image forming apparatus 100. The paper discharger 190 may be a pair of paper discharge rollers.

The processor 140 controls the image forming apparatus 100 as a whole to form an image on the printing paper S. Detection of whether double feed occurs in the conveyance device 1 by the processor 140 will be described hereinafter.

The processor 140 determines whether double feed occurs on the basis of a signal provided by the load sensor 50, and when it is determined that double feed has occurred, the processor 140 displays the double feed. For example, the processor 140 may inform the two conveyance devices 1 that double feed has occurred using the display 170 of the image forming apparatus 100.

The conveyance device 1 according to the present disclosure may also be applied to an automatic document scanning apparatus involving a non-conveyance, jamming, double feed, and a large-capacity conveyance device provided separately from the image forming apparatus.

According to the above-described conveyance device of the present disclosure, in the image forming apparatus having the conveyance device, since the conveyance device may determine whether double feed has occurred, double feed is detected and a recovery operation may be performed before a conveyance device driving source or a motor is damaged due to overload. In addition to that the conveyance device 1 can accurately measure and determine a state in which double feed has occurred, it is possible to immediately cope with double feed, preventing damage to a driving source or a motor and, and since occurrence of double feed is prevented in advance, damage to components may be prevented.

Thus, the present disclosure may also be applied to C path-type image forming apparatus, as well as to the S path-type image forming apparatus.

Hereinafter, a structure to enable the conveyance device according to the present disclosure to detect double feed of sheets will be described.

FIG. 5 is a view schematically illustrating an example of a conveyance device according to an example of the present disclosure, and FIG. 6 is a view illustrating a feed roller and a transfer roller of the conveyance device of FIG. 5.

Referring to FIGS. 5 and 6, the conveyance device 1 according to the present disclosure may include a cassette 10, a pickup roller 20, a feed roller 30, a conveyance roller 40, and a load sensor 50.

The cassette 10 is loaded with at least one sheet of paper S and may be formed to accommodate a predetermined number of sheets of printing paper S.

The pickup roller 20 is installed on the upper side of the cassette 10 and picks up the loaded sheets S one by one and feeds them to the feed roller 30. The pickup roller 20 may move the paper S positioned at the top of the paper S loaded in the cassette 10 toward the feed roller 30.

The pickup roller 20 rotates at a pickup position for picking up the paper S loaded in the cassette 10 and a separation position for separating the pickup roller 20 from the paper S. The pickup roller 20 is located at the pickup position when performing a feeding operation and may be located at the separation position when not performing the feeding operation.

The feed roller 30 is provided at the front end of the cassette 10 and moves the paper S loaded in the cassette 10 toward the transfer roller 60. The feed roller 30 moves the paper S picked up by the pickup roller 20 in the cassette 10 toward the transfer roller 60.

The transfer roller 60 is formed as a pair of rollers which rotate in a facing manner and moves the paper S fed by the feed roller 30 to the print engine 110. FIG. 1 shows a case where the conveyance device 1 according to the example of the present disclosure is installed in the image forming apparatus 100.

The conveyance roller 40 may face the feed roller 30 and prevent double feed of the printing paper S supplied from the cassette 10.

The conveyance roller 40 is rotatable in a forward or reverse direction with respect to a rotary shaft 42. The conveyance roller 40 is rotatably coupled to a hinge portion 44 and is movable to a pressing position at which the conveyance roller 40 presses the feed roller 30 and to a pressure releasing position at which the conveyance roller 40 is spaced apart from the feed roller. The conveyance roller 40 may rotate such that one end thereof presses the feed roller 30 or releases pressing of the feed roller 30 according to movements of a link 46 fixed to one end to the hinge portion 44.

When two or more sheets of paper are fed in a state in which the feed roller 30 is pressed, the conveyance roller 40 separates the paper so that one sheet of paper is fed to the print engine 110. The conveyance roller 40 may further include a torque limiter 45 applying a frictional resistance force in a direction opposite to the direction in which the paper is conveyed.

The conveyance roller 40, applying predetermined pressure to the printing paper S passing through between the feed roller 30 and the conveyance roller 40, may have a roller shape. The conveyance roller 40 is elastically deformed to form a conveyance nip allowing the printing paper S to pass through between the conveyance roller 40 and the feed roller 30.

The conveyance roller 40 is provided to be in contact with the feed roller 30 at a constant pressure. When a sheet of paper S is conveyed from the cassette 10, the paper S is rotated according to rotation of the feed roller 30 and transported toward the transfer roller 60. The conveyance roller 40 is elastically pressed toward the feed roller 30 so that the printing paper S conveyed between the conveyance roller 40 and the feed roller 30 comes into contact with the feed roller 30. In order to elastically press the conveyance roller 40 toward the feed roller 30, the elastic member 41 is connected to the conveyance roller 40. The elastic member 41 may apply elastic force to the conveyance roller 40 in the direction of the feed roller 30.

The elastic member 41 may be formed of a compression coil spring. However, the present disclosure is not limited thereto, and the elastic member 41 may have various shapes such as a compression coil spring, a tension coil spring, and the like.

The elastic member 41 may be disposed at a position for pressing the conveyance roller 40 toward the feed roller 30. One end of the elastic member 41 may be connected to the rotary shaft 42 of the conveyance roller 40, and the other end thereof is connected to a main body (not shown) of the image forming apparatus 100 or a frame 101 detachably attached to the main body. The elastic member 41 may be positioned between the conveyance roller 40 and the main body.

The elastic member 41 presses a lower part of the conveyance roller 40 to push up the conveyance roller 40 upwards. In a state in which the elastic member 41 is compressed, the conveyance roller 40 moves upwards and comes into contact with the feed roller 30. Here, the feed roller 30 and the conveyance roller 40 maintain contact pressure equivalent to an elastic force generated by the elastic member 41 being compressed.

The contact pressure generates a frictional force between the conveyance roller 40 and the feed roller 30, and when the printing sheet S loaded in the cassette 10 is picked up by the pickup roller 20 and introduced between the conveyance roller 40 and the feed roller 30, a frictional force acts as a conveyance force for conveying the printing sheet S to convey the printing sheet S to the transfer roller 60.

By installing the load sensor 50 sensing pressure at the elastic member 41, pressure between the conveyance roller 40 and the feed roller 30 may be sensed by the load sensor 50. The load sensor 50, serving to measure the elastic force of the elastic member 41, may be disposed at a lower end of the elastic member 41.

Contact pressure between the feed roller 30 and the conveyance roller 40 has a magnitude corresponding to the elastic force of the elastic member 41. Thus, a contact pressure in case where one sheet of printing paper S enters between the feed roller 30 and the conveyance roller 40 through the elastic force of the elastic member 41 and a contact pressure in case where two or more sheets of the printing paper S are double-fed may be measured. The conveyance device 1 may detect whether double feed has occurred by a difference between the contact pressure in the case of double feed and the contact pressure in case where one sheet of the printing paper S enters. The load sensor 50 may detect pressure between the feed roller 30 and the conveyance roller 40. The load sensor 50 may detect a change in pressure when two or more sheets of the printing paper S pass through between the feed roller 30 and the conveyance roller 40 on the basis of the case where one sheet of the printing paper S passes through between the feed roller 30 and the conveyance roller 40.

When the elastic member 41 is moved due to the pressure change between the feed roller 30 and the conveyance roller 40, the elastic force of the elastic member 41 is changed, and thus, the load sensor 50 may measure a change in contact pressure between the feed roller 30 and the conveyance roller 40.

The load sensor 50 is disposed on the elastic member 41 and is elastically supported by the elastic member 41. Therefore, although deformation or impact occurs in the image forming apparatus due to external force, or the like, such deformation or impact is not directly transmitted to the load sensor 50 but is alleviated by the elastic member 41, minimizing a decrease in pressure sensitivity of the load sensor 50 due to deformation or impact.

Further, since the load sensor 50 senses pressure between the feed roller 30 and the conveyance roller 40 through the elastic member 41, precision of pressure sensing may be increased.

The load sensor 50 may be at least one of a load sensor including a piezoelectric element, a piezoelectric sensor, and the like.

When the load sensor 50 is a piezoelectric element, a pressure value between the feed roller 30 and the conveyance roller 40 may be measured on the basis of an electrical signal output from the piezoelectric element. Piezoelectric elements are elements that output an electrical signal when a pressure is applied. Thus, the load sensor 50 may obtain a pressure value on the basis of the electrical signal output by the piezoelectric elements.

In the related art, in order to detect a paper jam phenomenon, an exit sensor is generally installed between the fixing device and the paper discharge roller. However, such an exit sensor, which is high in price, increases manufacturing cost and aggravates a paper jamming phenomenon due to malfunction, making it difficult to remove paper and damaging a peripheral component. Thus, the conveyance device 1 according to an example of the present disclosure has the load sensor 50 for sensing pressure applied to the feed roller 30.

In case where one sheet of paper S is introduced between the feed roller 30 and the conveyance roller 40, pressure applied to the feed roller 30 is greater than pressure applied to the feed roller 30 in case where two or more sheets of the paper are double-fed.

In a general case where one sheet of the printing paper S is introduced between the feed roller 30 and the conveyance roller 40, a first pressure may be applied to the load sensor 50, and when two or more sheets of the printing paper S enter between the fed roller 30 and the conveyance roller 40, second pressure may be applied to the load sensor 50. The second pressure when two or more sheets of the printing paper are fed is smaller than the first pressure when one sheet of the printing paper is fed. When the second pressure is applied to the load sensor 50, capacitance in the load sensor 50 is changed. When pressure is reduced from the first pressure to the second pressure, external pressure is decreased to reduce capacitance. It is possible to detect strength of pressure, or the like, using a variation of capacitance generated in the load sensor 50.

Although it is described that the load sensor 50 is disposed below the elastic member 41 pressing the conveyance roller 40 but the present disclosure is not limited thereto and the load sensor 50 may be installed in an elastic body for detecting pressure, apart from the elastic member 41 of the conveyance roller 40.

The image forming apparatus 1 according to an example of the present disclosure it may be possible to determine whether or not double feed occurs through a simple structure, and thus, control of detecting double feed by complicated ultrasonic sensor may not be performed.

The processor 140 determines whether double feed occurs on the basis of a signal provided from the load sensor 50.

When a printing mode is a continuous printing mode, the load sensor 50 senses pressure sensed by the load sensor 50 while each printing paper S is passing between the feed roller 30 and the conveyance roller 40 and provides the sensed pressure to the processor 140. The processor 140 sequentially records each pressure value of each printing paper S provided from the load sensor 50 in the memory 180. Here, the processor 140 may set a pressure value for a first sheet of the printing paper S, among the pressure values (current values) of the sheets, as a reference value for determining the occurrence of double feed. The reason for setting the pressure sensed when the first paper is printed as the reference value is because the probability of the occurrence of double feed in the first sheet in printing is not so high. The processor 140 may set a predetermined range based on the reference value to set a predetermined range for determining the occurrence of double feed.

As an example, a pressure value sensed by the load sensor 50 when double feed does not occur may be set in advance as a reference value in the memory 180 and the predetermined range and pressure of the load sensor 50 regarding each printing paper S may be compared to determine whether double feed has occurred.

When pressure sensed by the load sensor 50 while the printing paper S is passing between the feed roller 30 and the conveyance roller 40 is outside the predetermined range, the processor 140 may determine that double feed has occurred.

In addition, when it is determined that double feed has occurred, the processor 140 may control the conveyance roller 40 to return paper.

The feed roller 30, the conveyance roller 40, and a torque limiter 45 may be provided to separate paper in case where two or more sheets of paper are double-fed in the conveyance path.

The feed roller 30 and the conveyance roller 40 are engaged to rotate. The conveyance device 1 includes a driving source 121 for rotating the feed roller 30 and the conveyance roller 40. The feed roller 30 is connected to the driving source 121 and rotates in a direction to feed the printing paper S toward the print engine 110. A reverse rotational force transferring the printing paper S in the opposite direction of the print engine 110 is transmitted from the driving source 121 to the conveyance roller 40. To torque limiter 45 controls the reverse driving force transmitted to the conveyance roller 40. The torque limiter 45 may have various known structures.

When two or more sheets of paper S are drawn between the conveyance roller 40 and the feed roller 30, the conveyance roller 40 prevents the two or more sheets of paper S from passing between the conveyance roller 40 and the feed roller 30. Hereinafter, preventing two or more sheets of paper S from passing between the feed roller 30 and the conveyance roller 40 will be referred to as double-feed prevention.

The torque limiter 45 is provided in the conveyance roller 40 to prevent the paper S from being double-fed. The torque limiter 45 is installed coaxially with the rotary shaft 42 of the conveyance roller 40 and has a predetermined threshold torque value.

Therefore, if a sheet conveyance frictional force generated between the conveyance roller 40 and the feed roller 30 is greater than the threshold torque value, the sheet is rotated in the direction interworking with the rotation of the feed roller 30, that is, in a sheet conveyance direction.

However, if the sheet conveyance frictional force generated between the conveyance roller 40 and the feed roller 30 is smaller than the threshold torque value, the sheet does not rotate along the feed roller 30 but rotates in the opposite direction or is maintained in a stationary state.

Therefore, when a sheet of paper S is drawn between the conveyance roller 40 and the feed roller 30, a paper conveyance frictional force between the conveyance roller 40 and the paper S is greater than the threshold torque value of the torque limiter 40, and accordingly, the conveyance roller 40 rotates in a paper conveyance direction and the paper S is normally conveyed.

However, when two or more sheets of paper S are drawn between the conveyance roller 40 and the feed roller 30, the paper conveyance frictional force is smaller than the threshold torque value so the conveyance roller 40 is moved in a direction opposite to the sheet conveyance direction or stopped to prevent conveyance of the printing paper S.

The conveyance device 1 may further include the driving source 121 for rotating the feed roller 30 and the conveyance roller 40 and a feeding clutch (not shown) for selectively transmitting a rotational force of the driving source 121 to the feed roller 30. In this case, when it is determined that double feed has occurred, the processor 140 may control the feeding clutch to block a rotational force of the driving source 121 from being transmitted to the feed roller 30. Accordingly, when the conveyance roller 40 rotates in the direction opposite to the paper conveyance direction, the feed roller 30 may also rotate to follow the rotation of the conveyance roller 40 in the direction opposite to the paper conveyance direction.

The image forming apparatus according to the present disclosure may determine double feed through the simple pressure sensing structure and the low-priced load sensor, whereby double feed may be detected at low cost by utilizing a compact space,

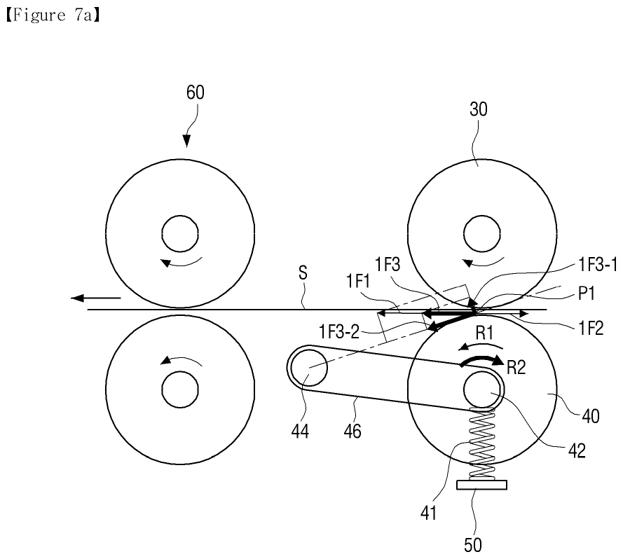

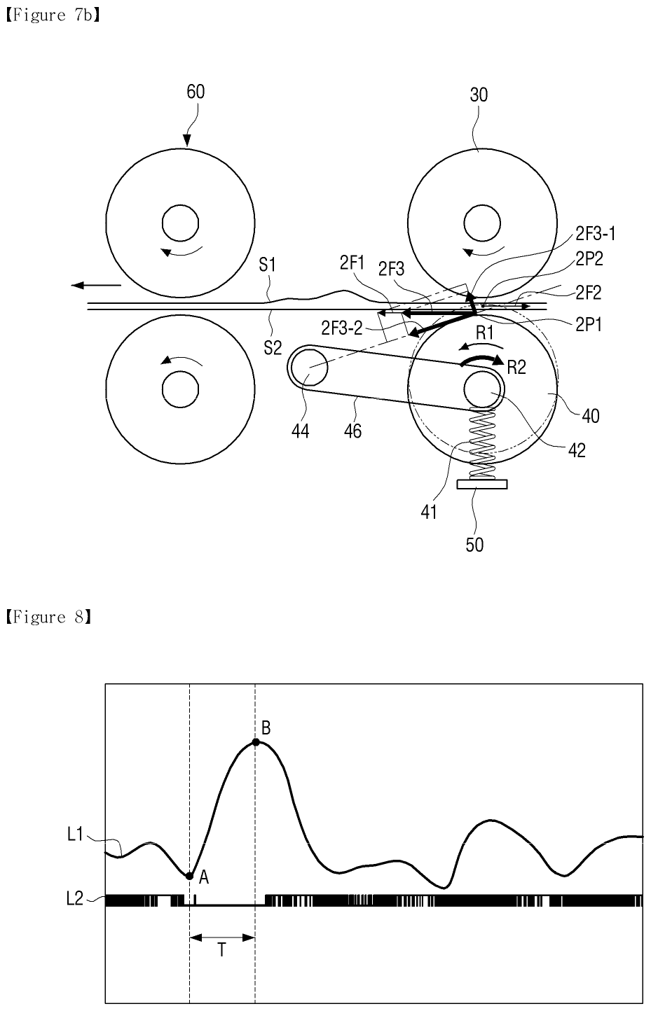

FIG. 7A is a view for explaining pressure measured by a load sensor when one sheet of printing paper is transferred on a conveyance device according to an example of the present disclosure, and FIG. 7B is a view for explaining pressure measured by a load sensor when two or more sheets of printing paper are double-fed on the conveyance device according to the example of the present disclosure.

Referring to FIG. 7A, when a sheet of printing paper S is conveyed between the conveyance roller 40 and the feed roller 30, the printing paper S is conveyed by the feed roller 30 and the conveyance roller 40 to the transfer roller 60 disposed at a downstream. Here, driving of the feed roller 30, which may not perform return driving, is interrupted and the feed roller 30 follows to rotate according to movement of the printing paper S pulled by a conveyance force of the transfer roller 60. The conveyance roller 40 also follows to rotate in an R1 direction according to movement of the printing paper S pulled by the conveyance force of the transfer roller 60.

At the same time, a reverse rotational force R2 of the conveyance roller 40 is transmitted to a surface 1P1 of the conveyance roller 40 with respect to a conveyance force 1F1 of the transfer roller 60, generating a horizontal friction drag 1F2 due to a coefficient of friction of rubber of the conveyance roller 40 and the printing paper S.

That is, the conveyance force 1F1 of the transfer roller 60 is reduced by the horizontal friction drag 1F2 generated at the contact surface where the conveyance roller 40 and the printing sheet S are in contact with each other.

As a result, a resultant force 1F3 of the conveying force 1F1 of the transfer roller 60 and the horizontal frictional force 1F2 is reduced by the horizontal friction drag 1F2 compared with the conveyance force 1F1 of the transfer roller 60.

From a positional relationship of the conveyance roller rotary shaft 42, an upward force 1F3-1 that the conveyance roller 40 applies to the feed roller 30 may be obtained from the resultant force 1F3. Through the upward force 1F3-1 applied to the feed roller 30 by the conveyance roller 40, a pressure between the conveyance roller 40 and the feed roller 30 is detected by the load sensor 50 adhered to the elastic member 41 of the conveyance roller 40.

A pressure applied to the conveyance roller 40 sensed by the load sensor 50 during conveyance of one sheet of printing paper S between the conveyance roller 40 and the feed roller 30 is the upward force 1F3-1.

Referring to FIG. 7B, when two or more sheets of printing paper S are conveyed between the conveyance roller 40 and the feed roller 30, the printing paper S is conveyed by the feed roller 30 and the conveyance roller 40 to the transfer roller 60 disposed at the downstream,

Here, driving of the feed roller 30, which may not perform return driving, is interrupted and the feed roller 30 follows to rotate according to movement of the printing paper S pulled by a conveyance force of the transfer roller 60. The conveyance roller 40 also follows to rotate in an R1 direction according to movement of the printing paper S pulled by the conveyance force of the transfer roller 60.

At the same time, the reverse rotational force R2 of the conveyance roller 40 with respect to the conveyance force 2F1 of the transfer roller 60 does not act on a position 2P1 between the conveyance roller 40 and the printing paper S2 in contact with the conveyance roller 40 but acts on a position 2P2 between two sheets S1 and S2 sandwiched between the feed roller 30 and the conveyance roller 40. A coefficient of friction between the conveyance roller 40 and the printing paper S2 is higher than a coefficient of friction between the lower conveyance paper S2 and the upper conveyance paper S1. Since the coefficient of friction between the sheet S1 and the sheet S2 is small, a horizontal friction drag force 2F2 generated between 2P2 the sheet S1 and the sheet S2 is smaller than a horizontal friction drag force 1F2 in case where one sheet of FIG. 7A is conveyed.

That is, the conveyance force 2F1 of the transfer roller 60 is reduced due to the horizontal friction drag 2F2 generated between 2P2 the sheet S1 and the sheet S2. As a result, a resultant force 2F3 of the conveyance force 2F1 of the transfer roller 60 and the horizontal frictional force 2F2 is lower by the horizontal friction drag 2F2 than the conveyance force 2F1 of the transfer roller 60.

From a positional relationship of the conveyance roller rotary shaft 42, an upward force 2F3-1 that the conveyance roller 40 applies to the feed roller 30 may be obtained from the resultant force 2F3. Through the upward force 2F3-1 applied to the feed roller 30 by the conveyance roller 40, a pressure between the conveyance roller 40 and the feed roller 30 is detected by the load sensor 50 adhered to the elastic member 41 of the conveyance roller 40.

A pressure applied to the conveyance roller 40 sensed by the load sensor 50 during conveyance of one sheet of printing paper S between the conveyance roller 40 and the feed roller 30 is the upward force 2F3-1.

Since the upward force (2F3-1) in the case of double feed is larger than the upward force 1F3-1 in the case of conveyance of one sheet, a pressure between the conveyance roller 40 and the feed roller 30 in the case of double feed is smaller than a pressure between the conveyance roller 40 and the feed roller 30 in the case of conveyance of one sheet. Therefore, the load sensor 50 senses a value smaller than a predetermined value for double feed.

Here, compared with the upward force 1F3-1 when one sheet of printing paper S is fed between the conveyance roller 40 and the feed roller 30, the upward force 2F3-1 when two or more sheets of printing paper S are conveyed between the conveyance roller 40 and the feed roller 30 has a larger value.

Also, when two or more sheets of printing paper S1 and 2 are fed between the conveyance roller 40 and the feed roller 30, the upper sheet Si is in contact with the feed roller 30 which is a rotation following side, and thus, the sheet S1 tends to be released between the transfer roller 60 and the feed roller 30. Thus, the degree of freedom of positional variation occurs between the sheet Si and the sheet S2 in which the horizontal friction drag force 2F2 is generated in the case of double feed, and thus, the upward force 2F3-1 may be further increased.

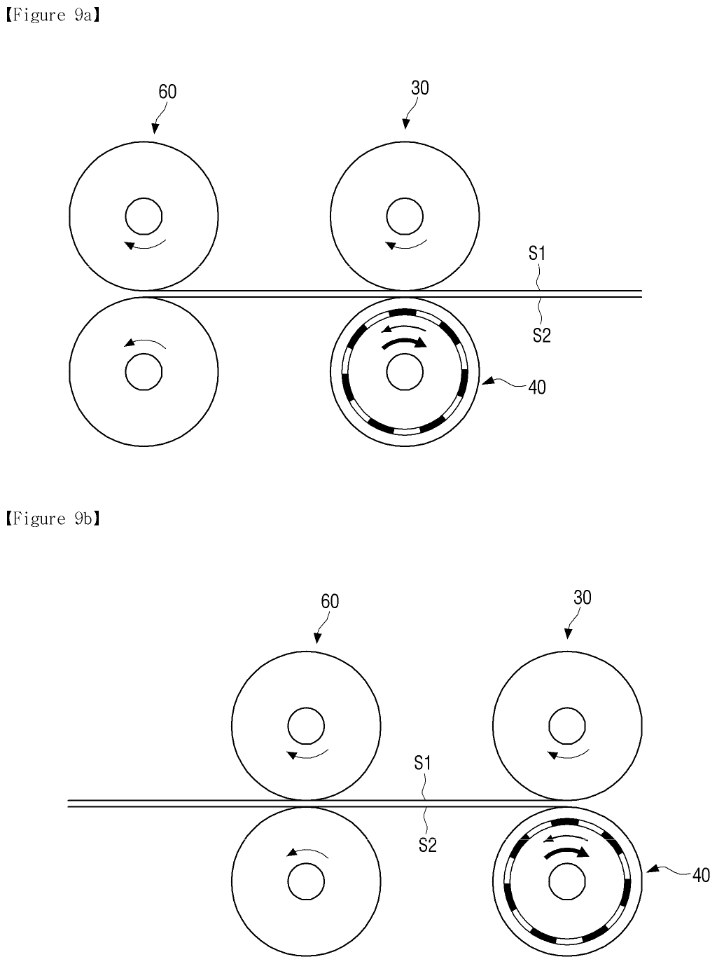

FIG. 8 is a view illustrating signals sensed by a sensor of a conveyance device according to an example of the present disclosure, FIG. 9A is a view illustrating a position of printing paper at a position A of FIG. 8, and FIG. 9B is a view illustrating a position of printing paper at point B of FIG. 8.

Referring to FIGS. 8, 9A and 9B, a first waveform L1 is a waveform representing pressure sensed by the load sensor 50 according to one example of the present disclosure.

The load sensor 50 according to the example of the present disclosure serves to measure a change in pressure of the elastic member 41 pressing the conveyance roller 40 toward the feed roller 30. The load sensor 50 is provided at the lower end of the elastic member 41. Accordingly, when the upward force 1F3-1 or 2F3-1 is applied by the conveyance roller 40 to the feed roller 30, since the load sensor 50 is pulled by the elastic member 41, a pressure signal sensed by the load sensor 50 is generated on a minus side. However, in FIG. 8, in order to help understand a pressure direction, the first waveform L1 of the pressure sensed by the load sensor 50 is reversely indicated.

When a variation in pressure sensed by the load sensor 50 while the printing paper S passes between the feed roller 30 and the conveyance roller 40 is equal to or greater than the predetermined value, the processor 140 determines that double feed has occurred.

When pressure sensed by the load sensor 50 while the printing paper S passes between the feed roller 30 and the conveyance roller 40 is outside the predetermined range, the processor 140 determines that double feed has occurred.

Referring to the first waveform L1, the variation in pressure between the points A and B sharply changes. Since the variation in the pressure at the point A is equal to or greater than the predetermined value, the processor 140 may determine that double feed occurs from the point A.

Referring to the first waveform L1, the pressure value sensed by the load sensor 50 after the point A is outside the predetermined range and maximized at the point B. The processor 140 may determine that double feed occurs between the point A and the point B.

A second waveform L2 is a waveform for detecting double feed using an ultrasonic sensor. It is illustrated that double feed is detected during a non-output section T in which no waveform is detected in the second waveform L2.

Accordingly, it can be confirmed that the result of detecting double feed using the load sensor 50 according to the example of the present disclosure is the same as the result of detecting double feed using the ultrasonic sensor.

Referring to FIG. 9A, the point A which is a lower limit position of pressure fluctuation is a position where the front end of the printing paper S reaches the transfer roller 60 and driving of the pickup roller 20 and the feed roller 30 which do not need to independently convey the printing paper S is cut off.

That is, the point A is a point where the transfer roller 60 initiatively conveys the printing paper S and the feed roller 30 and the conveyance roller 40 start to follow rotation on the paper S being conveyed.

It can be seen that, at this point, the upward force 1F3-1 or 2F3-1 rises vertically in the case of double feed.

Referring to FIG. 9B, the point B which is an upper limit position of the pressure fluctuation is a position where a trailing end of the printing paper S is separated from the feed roller 30 and the conveyance roller 40 and the feed roller 30 and the conveyance roller 40 are released from the external force of the printing paper S being conveyed. The upward force 1F3-1 or 2F3-1 is returned to the reference value after the point B.

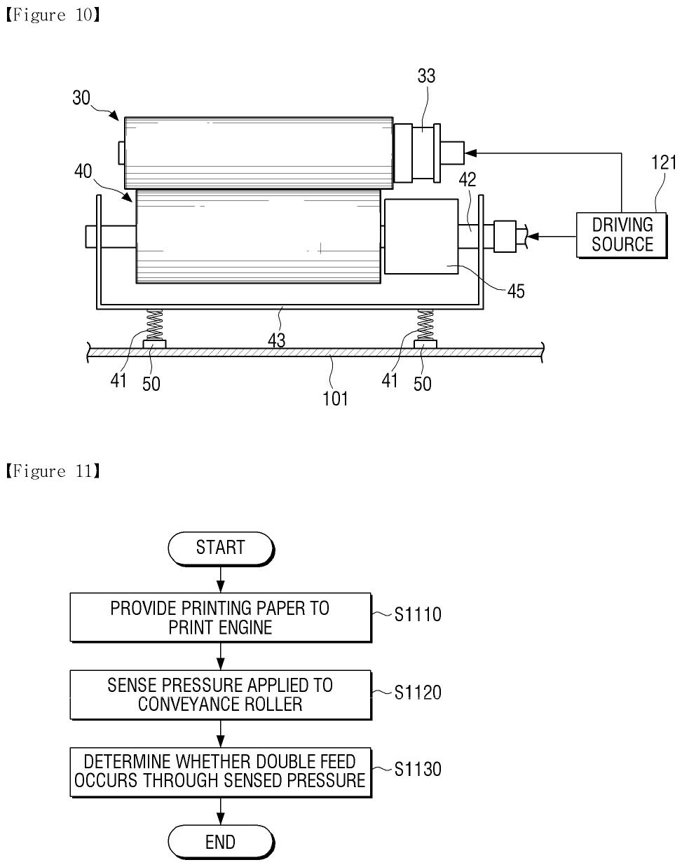

FIG. 10 is a view illustrating a feed roller and a transfer roller of a conveyance device according to another example of the present disclosure.

Referring to FIG. 10, a structure of a conveyance device according to another example of the present disclosure is the same as the structure of the conveyance device according to the example illustrated in FIG. 6 described above, except for the positions of the elastic member 41 and the load sensor 50. Therefore, descriptions of the feed roller 30, the conveyance roller 40, the torque limiter 45, and the driving source 121 of the conveyance device will be omitted.

In order to allow the conveyance roller 40 to be in contact with the feed roller 30 at constant pressure, the conveyance roller 40 may be elastically supported by a conveyance roller holder 43. The conveyance roller holder 43 is elastically supported by the elastic member 41 installed on the frame 3.

One end of the elastic member 41 may be connected to the conveyance roller holder 43 and the other end thereof may be connected to a main body (not shown) of the image forming apparatus 1 or the frame 101 detachably attached to the main body. The elastic member 41 may be positioned between the conveyance roller holder 43 and the main body.

The elastic member 41 presses and pushes up the conveyance roller 40 upwards. In a state in which the elastic member 41 is compressed, the conveyance roller 40 moves upwards and comes into contact with the feed roller 30. Here, the feed roller 30 and the conveyance roller 40 maintain contact pressure equivalent to an elastic force generated by the elastic member 41 being compressed.

Also, the load sensor 50 for measuring pressure between the feed roller 30 and the conveyance roller 40 may be disposed at the feed roller 30 that directly receives an upward force of the conveyance roller 40. The load sensor 50 may be disposed at a bearing 33 of the feed roller 30.

FIG. 11 is a flowchart for explaining a double feed sensing method in an image forming apparatus of the present disclosure.

Referring to FIG. 11, first, printing paper A picked up by the feed roller 30 and the conveyance roller 40 is provided to the print engine 110 (S1110). After initiation of an image, the printing sheet S loaded on the cassette 10 is picked up and subsequently moved to the conveyance path.

Pressure applied to the conveyance roller 40 is sensed using the load sensor 50 (S1120). This is to measure pressure applied to the sheet passing between the feed roller 30 and the conveyance roller 40 on the feeding path. A contact pressure when one sheet of printing paper S enters between the feed roller 30 and the conveyance roller 40 is sensed to be greater than contact pressure in case where two or more sheets of the printing paper S enter between the feed roller 30 and the conveyance roller 40.

Then, it is determined whether double feed occurs through the sensed pressure (S1130). If a variation in pressure provided by the load sensor 50 while the printing paper S is passing through the feed roller 30 is greater than a predetermined value, it is determined that double feed has occurred. Or, when pressure sensed by the load sensor 50 while the printing paper S is passing through the feed roller 30 is outside a predetermined range, it is determined that double feed has occurred.

When it is determined that double feed has occurred, if a paper conveyance frictional force generated between the conveyance roller 40 and the feed roller 30 is smaller than a threshold torque value of the torque limiter 45, the conveyance roller 40 is driven in a reverse direction opposite to the conveyance direction of the printing paper S.

Examples have been described but the present disclosure is not limited to these examples and various modifications may be made without departing from the scope of the present disclosure claimed in the claims, and such modifications should not be individually understood from technical concepts or prospects of the present disclosure.

What is claimed is:

1. An image forming apparatus including:
a print engine to form an image on an image forming medium;
a conveyance device to provide printing paper to the print engine using a feed roller and a conveyance roller installed to face the feed roller;
a sensor to sense pressure applied to the conveyance roller; and
a processor to identify whether double feed occurs based on a signal provided from the sensor.

2. The image forming apparatus as claimed in claim 1, wherein when a variation of pressure sensed by the sensor while the printing paper is passing through the feed roller is equal to or greater than a predetermined value, the processor identities that double feed occurs.

3. The image forming apparatus as claimed in claim 1, wherein when pressure sensed by the sensor while the printing paper is passing through the teed roller is outside a predetermined range, the processor identifies that double feed occurs.

4. The image forming apparatus as claimed in claim 1, further including:
a torque limiter installed coaxially with the conveyance roller, the torque limiter having a predetermined threshold torque value,
wherein when a paper conveyance frictional force generated between the conveyance roller and the feed roller is smaller than the threshold torque value, the processor controls the conveyance roller to be driven in a reverse direction opposite to a conveyance direction of the printing paper.

5. The image forming apparatus as claimed in claim 4, wherein when the conveyance roller is driven in the reverse direction, the processor identifies double feed based on a signal from the sensor.

6. The image forming apparatus as claimed in claim 5, wherein when it is identified that double feed occurs, the processor controls the feed roller to be reversely rotated.

7. The image forming apparatus as claimed in claim 1, wherein
the conveyance device further includes:
a driving source to rotate the feed roller and the conveyance roller; and
a feeding clutch to selectively transmit rotational force from the driving source to the feed roller,
wherein when it is identified that double feed occurs, the processor controls the feeding clutch to transmit rotational force from the driving source to the feed roller.

8. The image forming apparatus as claimed in claim 1, wherein the sensor is a load sensor including a piezoelectric element and a piezoelectric sensor.

9. The image forming apparatus as claimed in claim 1, further including:
an elastic member to provide an elastic force pressing the conveyance roller toward the feed roller,
wherein the sensor is disposed at a lower end of the elastic member,

10. The image forming apparatus as claimed in claim 1, further including:
a display,
wherein when double feed is identified, the processor controls the display to display a notification.

11. The image forming apparatus as claimed in claim 1, wherein
the sensor is disposed at the feed roller, and the feed roller is to directly receive an upward force from the conveyance roller.

12. A method to detect double feed in an image forming apparatus, the method including:
providing printing paper to a print engine using a feed roller and a conveyance roller installed to face the feed roller;
sensing pressure applied to the conveyance roller using a sensor; and
identifying whether double feed occurs on the basis of a signal provided from the sensor.

13. The method as claimed in claim 12, wherein
in the sensing of whether double feed occurs, when a variation of pressure sensed by the sensor while the printing paper is passing through the feed roller is equal to or greater than a predetermined value, the processor identifies that double feed occurs.

14. The method as claimed in claim 12, wherein
in the sensing of whether double feed occurs, when pressure sensed by the sensor while the printing paper is passing through the feed roller is outside a predetermined range, the processor identifies that double feed occurs.

15. The method as claimed in claim 12, further including:
when double feed occurs, if a paper conveyance frictional force generated between the conveyance roller and the teed roller is smaller than a threshold torque value of a torque limiter, driving the conveyance roller in a reverse direction opposite to a conveyance direction of the printing paper.
